(19) United States
(12) Patent Application Publication
(10) Pub. No.: US 2025/0277711 A1
(43) Pub. Date: Sep. 4, 2025

(54) HIGH RESOLUTION STRAIN MAPPING SENSOR

(71) Applicant: Khalifa University of Science And Technology, Abu Dhabi (AE)

(72) Inventors: Olyad Dereje Emiru, Abu Dhabi (AE); Natnael Abule Takele, Abu Dhabi (AE); Nidal Rifki, Abu Dhabi (AE); Mahmoud Meribout, Abu Dhabi (AE); Mohamed Abdel Aziz Mohamed Elkhalil, Abu Dhabi (AE); Varun Kumar Tiwari, Dubai (AE)

(21) Appl. No.: 19/061,224

(22) Filed: Feb. 24, 2025

Related U.S. Application Data
(60) Provisional application No. 63/561,049, filed on Mar. 4, 2024.

(51) Int. Cl. G01L 1/22

(52) U.S. Cl. CPC G01L 1/225; G01L 1/2287

(57) ABSTRACT

Embodiments of the present technology may include a strain mapping sensor. The strain mapping sensor can include a set of electrodes. The strain mapping sensor can further include at least three layers. Each of the at least three layers can be formed a rigid material, a flexible material, or a stretchable material. The at least three layers can include a first electrically conductive layer. The first electrically conductive layer can be connected to a voltage or current source. The at least three layers can further include a second electrically conductive layer. Additionally, the at least three layers can include a third layer. The second electrically conductive layer can have a first surface and a second surface. At least one electrode of the set of electrodes can be positioned on the second surface and electrically coupled with the second electrically conductive layer.

### CROSS-REFERENCES TO RELATED APPLICATIONS

This application claims the benefit of U.S. Provisional Patent Application No. 63/561,049, filed Mar. 4, 2024, the entire contents of which are hereby incorporated by reference for all purposes in its entirety.

### BACKGROUND OF THE INVENTION

Flexible and Stretchable sensors can have a wide range of applications including virtual and mixed reality, tactile sensing, human motion detection, therapeutics, industrial training, and soft robots. A good portion of these sensors can use an electrical impedance tomography (EIT) technique by deploying an array of electrodes on a sensor boundary and proceeding with current injection and voltage readings across different electrodes pairs. For instance, an EIT system can use sixteen electrodes, evenly distributed inside a tactile sensor to detect up to three eventual contacts. Another sixteen electrode EIT system can assess five simultaneous contact points in experiments. A deep neural Network-based EIT system of multiple (e.g., sixteen or twenty-eight) electrodes can be implemented. However, EIT systems can have disadvantages. For example, EIT systems may accommodate limited number of contact points, such as around five contact points at most. EIT systems can be challenged to accommodate variable resistances which may be induced at the contact points, and therefore EIT systems may not measure strain intensity in such cases. Additionally, EIT systems can feature weak accuracy in areas which are away from the electrodes. This weak accuracy can arise following a linearization of a highly non-linear inverse problem to reduce computation time and accommodate a light weight EIT system. In EIT systems, an electrical current generated by an electric current source may be assumed constant irrespective of the resistive load, which may not be the case in practice, where twenty percent changes can be exhibited for only a few kilo-ohm load change. In addition, conductivities of both conductive and middle compressible layers may not be uniform since these layers may typically be fabricated by injecting conductive/non-conductive liquid-conductor or particle composites into a non-conductive/conductive substrate. This nonuniformity in conductivities can lead to substantial uncertainties in an image reconstruction process which can assume that a conductivity of a background material is low and uniform. Injecting ionic liquid can overcome a non-uniformity issue, however such an injection can expose a sensor to unpredictable leaks in practical use.

### BRIEF SUMMARY OF THE INVENTION

A system described herein can include a strain mapping sensor. The strain mapping sensor can include a set of electrodes. The strain mapping sensor can further include at least three layers. Each of the at least three layers can be formed a rigid material, a flexible material, or a stretchable material. The at least three layers can include a first electrically conductive layer. The first electrically conductive layer can be connected to a voltage or current source. The at least three layers can further include a second electrically conductive layer. Additionally, the at least three layers can include a third layer. The third layer can be positioned between the first electrically conductive layer and the second electrically conductive layer. The second electrically conductive layer can have a first surface and a second surface opposite the first surface. The third layer can be positioned such that the first surface is towards the third layer. At least one electrode of the set of electrodes can be positioned on the second surface and electrically coupled with the second electrically conductive layer.

### BRIEF DESCRIPTION OF THE DRAWINGS

FIG. 1A is a schematic of a multilayer sensor system with a current excitation source according to certain aspects of the present disclosure.

FIG. 1B is a schematic of a multilayer sensor system with a voltage excitation source according to certain aspects of the present disclosure.

FIG. 2 is a schematic of a layer for a multilayer sensor with an electrically conductive medium including an insulating substrate and segmented conducting tracks according to certain aspects of the present disclosure.

FIG. 3A is a schematic of an equivalent electric circuit for a multilayer sensor system with a voltage excitation source according to certain aspects of the present disclosure.

FIG. 3B is a schematic of an equivalent electric circuit for a multilayer sensor system with a current excitation source according to certain aspects of the present disclosure.

FIG. 3C is a schematic of an equivalent electric circuit for a multilayer sensor system with a current excitation source and two short-circuited electrodes according to certain aspects of the present disclosure.

FIG. 4 is a schematic of a multilayer sensor system with a current excitation source and multiple multiplexers according to certain aspects of the present disclosure.

FIG. 5 is a schematic of an artificial neural network (ANN) for a multilayer sensor system according to certain aspects of the present disclosure.

FIG. 6 is a schematic of a multilayer sensor system with a voltage excitation source configured to determine multiple locations of applied stress according to certain aspects of the present disclosure.

FIG. 7 is a schematic of two layers of a multilayer sensor system according to certain aspects of the present disclosure.

FIG. 8 is a schematic top view of an equivalent circuit of a multilayer sensor system configured to determine multiple locations of applied stress according to certain aspects of the present disclosure.

FIG. 9 is a graph of excitation voltage Vᵢₙ as a function of time for a multilayer sensor system according to certain aspects of the present disclosure.

FIG. 10 is a flow chart of a process for determining locations and intensities of applied strains on a multilayer sensor system according to certain aspects of the present disclosure.

FIG. 11 is a block diagram of a controller for a multilayer sensor system according to certain aspects of the present disclosure.

### DETAILED DESCRIPTION OF THE INVENTION

Disadvantages of EIT systems can lead researchers to consider non-EIT tactile sensors. Non-EIT sensors can include a lattice arrangement of small-sized sensing elements on a deformable base material. For in instance, examples of non-EIT sensors can include a tactile glove including five-hundred forty-eight piezoresistive sensors connected to a network of sixty-four conductive thread electrodes. The glove can be trained with 135,000 frames corresponding to 26 different objects located at different positions to yield a very slow framerate of 7.3 Hz. Each piezoresistive sensor of the glove can measure one-hundred fifty different strain levels ranging from 30 mN to 0.5 N. The tactile glove system may be a better alternative to EIT-based systems since the glove system can accurately handle simultaneously multiple contact points. However, a large number of embedded sensors having electrodes sewed inside each strain sensor can make a manufacturing process increasingly challenging, particularly with any enlargement of a size of the glove sensors. Further, a generation of induced spurious current paths and crosstalk can occur, caused partly by a short circuit between nearby electrodes. Another alternative can involve a modularized texels-based technique, which may offer simple large-area coverage by using a honeycomb structure. Also, sensor reliability may be enhanced using an indexed wiring technique to improve conformability and durability. Nevertheless, both these two techniques may require excessive internal wirings with limitations of susceptibility to sensor connection breaks and a heavy data communication burden. A hybrid wearable glove may mitigate disadvantages of other techniques. The hybrid wearable glove can use both resistive and pressure sensors based on fluid. The fluid can be air or gas that is carried within soft tubes (e.g., six soft tubes). Two sensing modalities of the hybrid wearable glove can be decoupled, and the glove can target a hand-pose estimation application, estimate object temperatures, and identify objects taken by the hand. However, sensors of the hybrid wearable glove can be prone to leaks, may not be sensitive to physio-chemical variations of the fluid, and can be complex to manufacture. Furthermore, a point-to-point communication between contact points and a controller of the hybrid wearable glove may induce substantial interference which can increase a function of the contact points sought in the device. Also, electronics of the hybrid wearable glove can allow a frame acquisition throughput of 0.35 seconds/frame which is excessively high for high-speed applications (e.g., slip detection applications).

Overall, strain mapping sensors can rely on a change of electrical properties of flexible materials as a function of applied strain. Capacitance and, to higher extent, piezo-resistive methods can commonly be applied. Piezo-resistive methods can be preferred due to a complexity of signal conditioning circuitry of capacitance-based sensors when small area strains are sought for detection within a large sensing area. Nevertheless, piezo-resistive materials may not be uniform and can feature a high hysteresis value which can make signals readings unreliable. The high hysteresis value may be caused by a change of material-conductivity over time, irrespective of an intensity of applied strain.

Certain aspects and examples of the present disclosure relate to a multilayer strain mapping sensor, or multilayer sensor. The multilayer sensor may overcome some of the limitations of existing strain mapping sensors and other sensor types. For example, the multilayer sensor can accommodate a large number of simultaneous strain contacts and estimate corresponding strain intensities. Additionally, the multilayer sensor can compensate for electrical resistance changes which may be induced by temperature variations. Unlike most non-EIT stain mapping sensors, the multilayer sensor can place electrodes at a boundary of the multilayer sensor, which can make expansion easier for accommodating large areas. An excitation signal which can be generated by either a current source or a voltage source may be an AC periodical signal which can have an advantage of mitigating eventual low frequency/DC electromagnetic interference noises.

The multilayer sensor can quickly switch between electrodes to yield a very high frame rate. More specifically, the multilayer sensor can be a high-resolution strain mapping sensor that can include a stack of at least three layers, where a middle layer can be a compressible layer, an electric resistance of which can be very high for zero applied strain and can substantially reduce as a function of the applied strain. The middle layer can include a strain-compressible material, such as foam. Two other layers can include a very high electrically conductive medium, a resistance of which can change only marginally as a function of temperature or strain contacts. The electrically conductive medium can be either a highly conductive material or an insulating substrate with segmented conductive tracks on a sensor boundary. The multilayer sensor can measure positions as well as values of strains applied at different locations of the sensor.

An array of electrodes can be placed on the sensor boundary to determine locations of points of contacts on the sensor, as well as an amount or intensity of strain applied. The three layers can be made of rigid, flexible, and/or stretchable materials based on an application for the multilayer sensor. In some examples, the multilayer sensor can be deployed within wearable articles for targeted tactile sensing. The multilayer sensor can easily be manufactured on a large scale and can be scalable for deployment in large areas sensing. Thus, the multilayer sensor can be an attractive for use in applications where large area tactile sensors are suitable, such as covering a whole humanoid robot. In addition, electrode placement at the boundary of the multilayer sensor can initiate a simple production manufacturing process and can prevent uncertainties of measurements which may be induced when strain is applied on an electrode. Depending on precision and resolution sought, the multilayer sensor can include multiple stacks of three-layer sensors.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

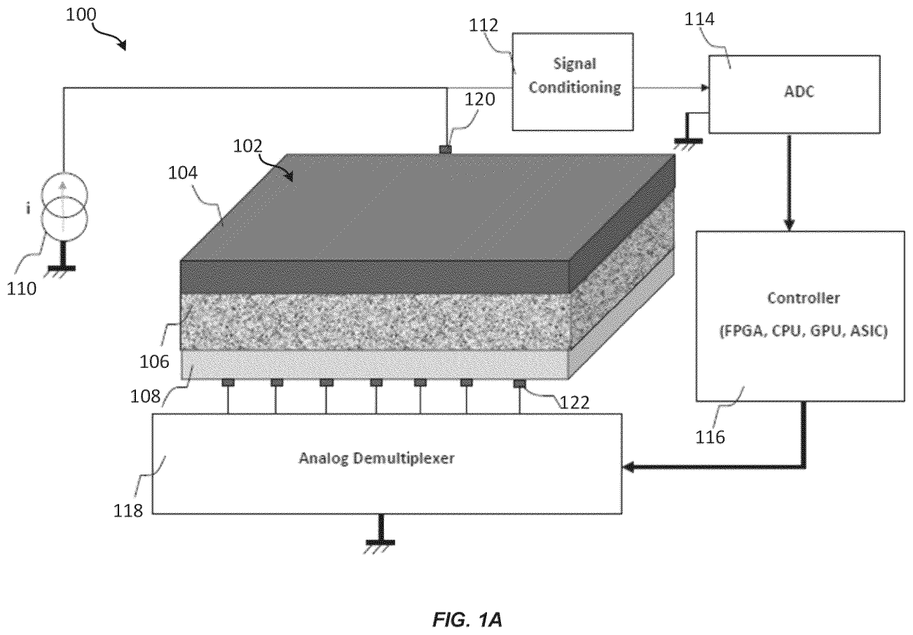

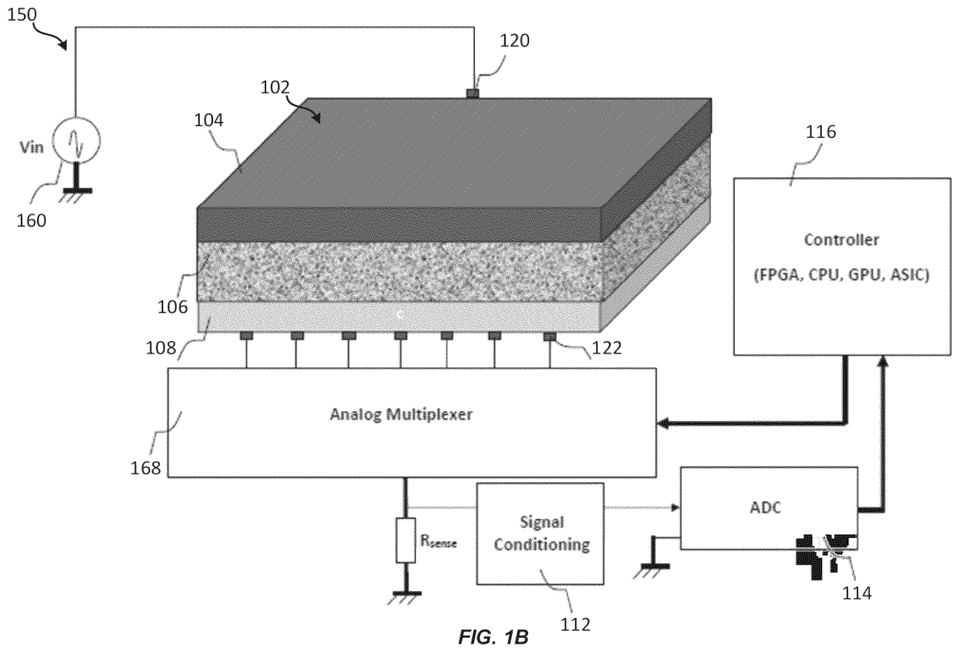

FIG. 1A is a schematic of a multilayer sensor system 100 with a current excitation source 110 according to certain aspects of the present disclosure. The multilayer sensor system 100 can include a multilayer sensor 102, the current excitation source 110, a signal conditioning unit 112, an analog-to-digital converter (ADC) 114, a controller 116, and an analog demultiplexer 118. The current excitation source 110 can be an alternating current (AC) or a direct current (DC) current source. The multilayer sensor 102 can include multiple layers, such as a top layer 104, a middle layer 106, and a bottom layer 108. While three layers are shown in the multilayer sensor 102 in FIG. 1A, the multilayer sensor 102 can include any number of layers. In some examples, the multilayer sensor 102 can include multiple stacks of multilayers. For example, the multilayer sensor 102 can include any number of stacks of three-layer multilayers. Each stack can include a multilayer with a different number of layers. As an example, the multilayer sensor 102 can include three stacks of two-layer sensors on top of four stacks of three-layer sensors.

A surface of the top layer 104 can include an electrode 120. While a single electrode is shown on the surface of the top layer 104 in FIG. 1A, any number of electrodes can be included on the surface of the top layer 104 including zero electrodes. A surface of the bottom layer 108 can include electrodes 122. While seven electrodes are shown on the surface of the bottom layer 108 in FIG. 1A, for simplicity only one electrode in labeled in FIG. 1A. Any number of electrodes can be included on the surface of the bottom layer 108 including zero electrodes. The electrode 120 and the electrodes 122 can be placed along a boundary of the multilayer sensor 102.

In some examples, the middle layer 106 can be a compressible layer with an electric resistance that can vary with applied strain. For example, the resistance of the middle layer 106 can be very high for zero applied strain and can substantially reduce as a function of the applied strain. The top layer 104 and the bottom layer 108 can include a very high electrically conductive medium, a resistance of which can change only marginally as a function of temperature or strain contacts. The electrically conductive medium can be a highly conductive material. In some examples, the electrically conductive medium of the bottom layer 108 can be an insulating substrate with segmented conductive tracks on a sensor boundary.

The controller 116 can be a field programmable gate array (FPGA), a central processing unit (CPU), a graphics processing unit (GPU), or an application-specific integrated circuit (ASIC). The electrode 120 can be electrically coupled to the top layer 104 and to the current excitation source 110. The electrodes 122 can be electrically coupled to the bottom layer 108 and to the analog demultiplexer 118. In some examples, a single electrode of the electrodes 122 can be connected to ground at any time through the analog demultiplexer 118. The analog demultiplexer 118 can be electrically coupled to the controller 116, which can configure the analog demultiplexer 118.

FIG. 1B is a schematic of a multilayer sensor system 150 with a voltage excitation source 160 according to certain aspects of the present disclosure. The multilayer sensor system 150 can include a multilayer sensor 102, the voltage excitation source 160, a signal conditioning unit 112, an ADC 114, a controller 116, and an analog multiplexer 168. The voltage excitation source 160 can be an AC or a DC voltage source. The multilayer sensor 102 can include multiple layers, such as a top layer 104, a middle layer 106, and a bottom layer 108. While three layers are shown in the multilayer sensor 102 in FIG. 1B, the multilayer sensor 102 can include any number of layers. In some examples, the multilayer sensor 102 can include multiple stacks of multilayers. For example, the multilayer sensor 102 can include any number of stacks of three-layer multilayers. Each stack can include a multilayer with a different number of layers. As an example, the multilayer sensor 102 can include three stacks of two-layer sensors on top of four stacks of three-layer sensors.

A surface of the top layer 104 can include an electrode 120. While a single electrode is shown on the surface of the top layer 104 in FIG. 1B, any number of electrodes can be included on the surface of the top layer 104 including zero electrodes. A surface of the bottom layer 108 can include electrodes 122. While seven electrodes are shown on the surface of the bottom layer 108 in FIG. 1B, any number of electrodes can be included on the surface of the bottom layer 108 including zero electrodes. For simplicity only one electrode of the electrodes 122 is labeled in FIG. 1A. The electrode 120 and the electrodes 122 can be placed along a boundary of the multilayer sensor 102.

In some examples, the middle layer 106 can be a compressible layer with an electric resistance that can vary with applied strain. For example, the resistance of the middle layer 106 can be very high for zero applied strain and can substantially reduce as a function of the applied strain. The top layer 104 and the bottom layer 108 can include a very high electrically conductive medium, a resistance of which can change only marginally as a function of temperature or strain contacts. The electrically conductive medium can be a highly conductive material. In some examples, the electrically conductive medium of the bottom layer 108 can be an insulating substrate with segmented conductive tracks on a sensor boundary.

The controller 116 can be a FPGA, a CPU, a GPU, or an ASIC. The electrode 120 can be electrically coupled to the top layer 104 and to the voltage excitation source 160. The electrodes 122 can be electrically coupled to the bottom layer 108 and to the analog multiplexer 168. In some examples, a single electrode of the electrodes 122 can be connected to ground at any time through the analog multiplexer 168. The analog multiplexer 168 can be electrically coupled to the controller 116, which can configure the analog multiplexer 168. Depending on characteristics of the ADC 114, multiple designs of a signal conditioning circuit can be considered. For instance, the signal conditioning circuit can include a voltage inverter followed by a 75-ohm series resistance to satisfy an impedance matching condition.

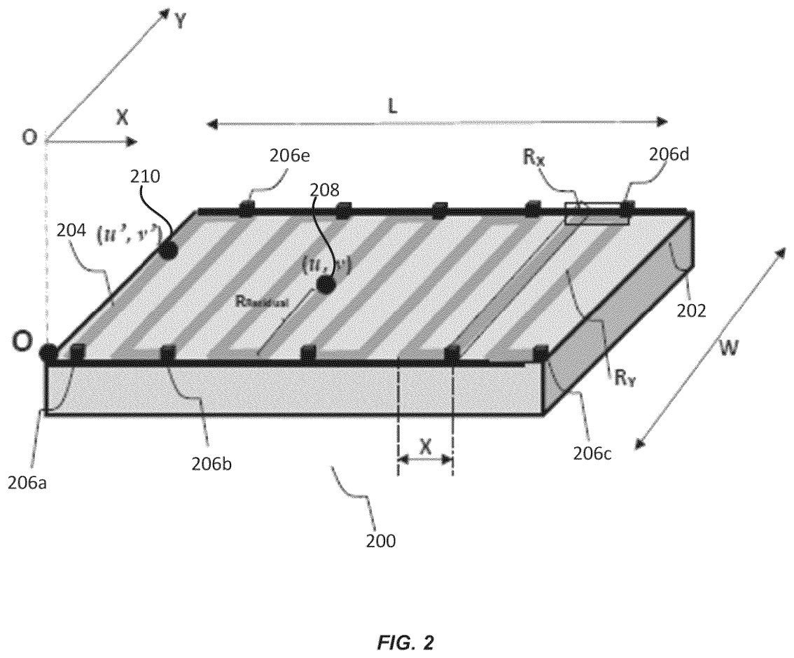

FIG. 2 is a schematic of a layer 200 for a multilayer sensor with an electrically conductive medium including an insulating substrate 202 and segmented electrically conductive tracks (referred to as segmented conducting tracks 204) according to certain aspects of the present disclosure. The multilayer sensor can be, for example, multilayer sensor 102 from FIG. 1A or FIG. 1B. The layer 200 can be, for example, top layer 104, middle layer 106, or bottom layer 108 from FIG. 1A or FIG. 1B. The insulating substrate 202 can be a nonconducting film. The film can be rigid, flexible, stretchable, or some combination of the aforementioned characteristics. The segmented conducting tracks 204 can be attached to the insulating substrate 202 using an adhesion technique, such as gluing or sewing. In some examples, the segmented conducting tracks 204 can be permanently fixed to the insulating substrate 202.

The layer 200 can have a top surface with a length L and width W. Locations on the top surface can be described with an x-y coordinate system having an origin O on the top surface. The x-y coordinate system can estimate two-dimensional (2D) positions of locations of applied strain on the multilayer sensor. The segmented conducting tracks 204 can include a plurality of y segments and a plurality of x segments. The y segments can be connected together by the x segments. Each y segment can have an electrical resistance, R_{Y} and each x segment can have an electrical resistance, R_{X}. The length of each y segment can be equivalent to the width, W. The length of each x segment can be defined as X. As shown in FIG. 2, the segmented conducting tracks 204 can feature a zigzag shape of continuous L-shaped patterns of length W and width X that covers an entire length of the layer 200. The total length D of the segmented conducting tracks 204 can be expressed as:

$$D = \frac{L}{X} \times W \qquad ( 1 )$$

The layer 200 can also include several electrodes. For simplicity, only some of the electrodes in FIG. 2 are labeled, such as electrodes 206a-e. Although ten electrodes are shown in FIG. 2, the layer 200 can include any number of electrodes. Each of the electrodes can be electrically coupled to the segmented conducting tracks 204. Locations along the track can be described using the x-y coordinate system. For example, a first location 208 along the segmented conducting tracks 204 can be described by x-y coordinates (u, v) and a second location 210 along the segmented conducting tracks 204 can be described by x-y coordinates (u′, v′). Resistance measurements can be affected by a location of an applied stress. For example, a resistance measurement between the origin and the first location 208 can have a lower value than a resistance measurement between the origin and the second location 210. The lower value in resistance can be due to a shorter length of the segmented conducting tracks between the origin and the first location 208 than between the origin and the second location 210. As shown in FIG. 2, a resistance of the y segment associated with the first location 208 can be R_{residual}, which can be lower than R_{Y}, since the first location 208 is located between endpoints of the y segment.

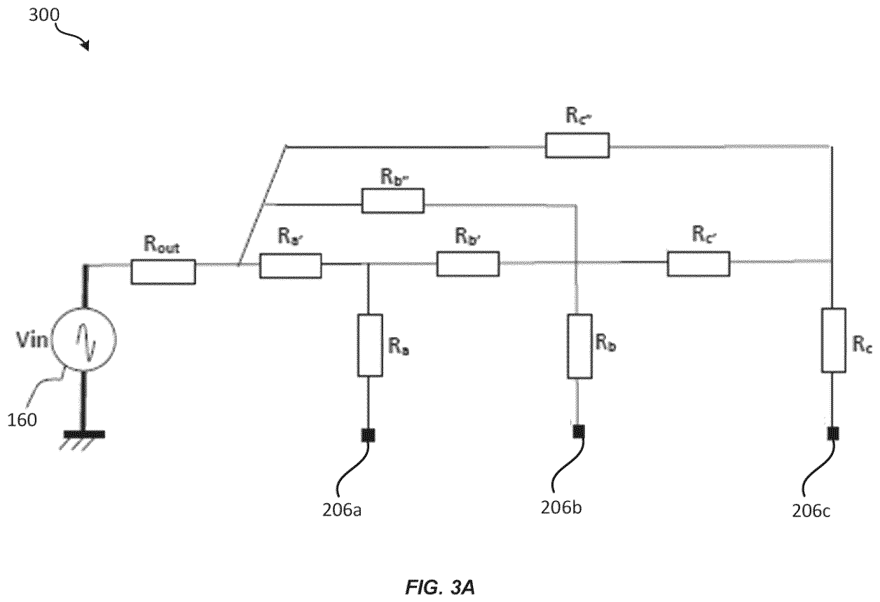

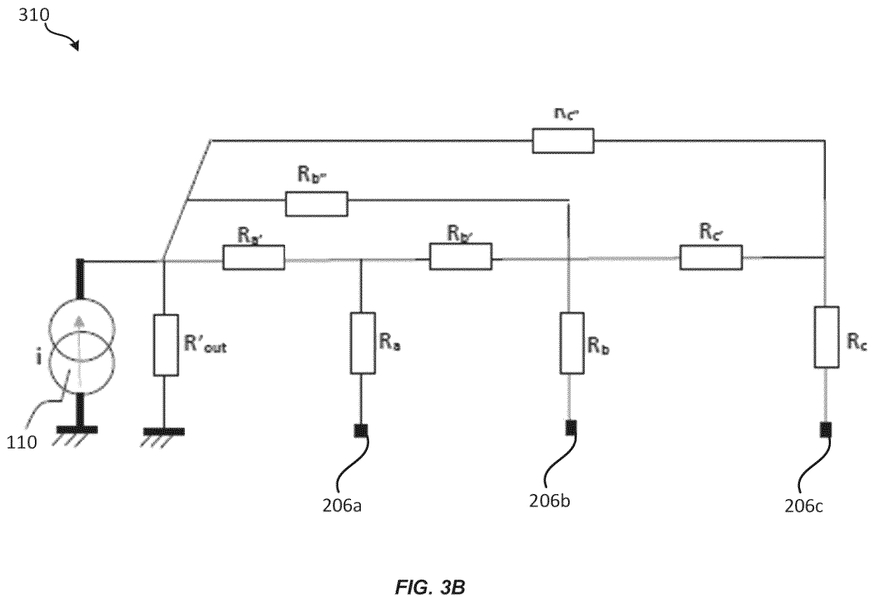

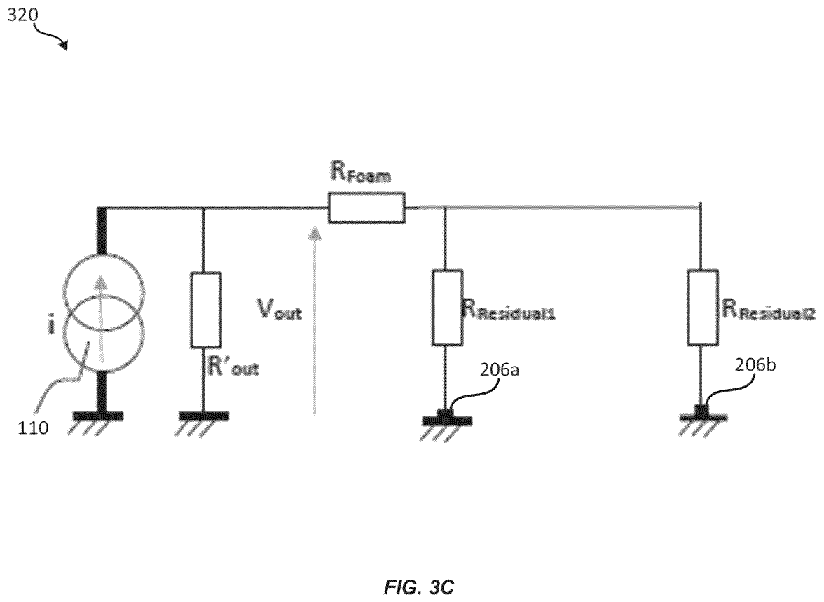

FIG. 3A is a schematic of an equivalent circuit 300 for a multilayer sensor system with a voltage excitation source 160 according to certain aspects of the present disclosure. The equivalent circuit 300 can include a small output resistance Rout associated with the voltage excitation source 160 followed by a cascade of T-shaped circuits. Values of parallel resistances (e.g., Rₐ, R_{b}, R_{c}, etc.) connected to electrodes 206a-c, series resistances (e.g., R_{a′}, R_{b′}, R_{c′}, etc.), and shunt resistances (e.g., R_{a″}, R_{b″}, etc.) can depend on locations and intensities of strains applied to a multilayer sensor of the multilayer sensor system.

FIG. 3B is a schematic of an equivalent electric circuit 310 for a multilayer sensor system with a current excitation source 110 according to certain aspects of the present disclosure. The equivalent circuit 310 can include a large output resistance R′ₒᵤₜ associated with the current excitation source 110 followed by a cascade of T-shaped circuits. Values of parallel resistances (e.g., Rₐ, R_{b}, R_{c}, etc.) connected to electrodes 206a-c, series resistances (e.g., R_{a′}, R_{b′}, R_{c′}, etc.), and shunt resistances (e.g., R_{a″}, R_{b″}, etc.) can depend on locations and intensities of strains applied to a multilayer sensor of the multilayer sensor system.

Circuit topologies of both FIG. 3A and FIG. 3B can be complex and involve some hardware simplifications by isolating areas of interests using analog switches and analog multiplexers, such as analog demultiplexer 118 shown in FIG. 1A or analog multiplexer 168 shown in FIG. 1B. Referring to FIG. 1A and FIG. 2 and considering current excitation source 119, in a case where no strain is applied on multilayer sensor 102, an input voltage of ADC 114 can be negligible when any of the electrodes 122 is grounded as an electrical resistance of middle layer 106 can be high. When a single contact strain is applied at a location on the sensor, (e.g., first location 208 of FIG. 2) of the multilayer sensor 102, input voltage V₂₀₆ₐ of the ADC 114 when one of the electrodes 122 (e.g., electrode 206a shown in FIG. 2) is grounded can be expressed as:

$${V}_{206 a} = [ {R}_{foam} + k {R}_{L} + {R}_{r e s i d u a l} ] \times I \qquad ( 2 )$$

where R_{foam} is the resistance of the middle layer 106 at the location of applied strain, k is a number of L segments in the segmented conducting tracks 204 along a path from the grounded electrode to the location of applied strain, R_{L} is a resistance of an L segment, R_{residual} is a resistance of a remaining track beyond the last complete L segment along the path from the grounded electrode to the location of applied strain, and I is an applied electric current.

Assuming that R_{foam} is known, a determination of x-y coordinates (e.g., (u, v) of first location 208 of FIG. 2) of the location of applied strain can involve a second voltage reading with a different grounded electrode. For example, the different grounded electrode can be electrode 206b from FIG. 2 and the second voltage reading V_{206b} can be expressed as:

$${V}_{206 b} = [ {R}_{foam} + ( k - 1 ) {R}_{L} + {R}_{r e s i d u a l} ] \times I \qquad ( 3 )$$

Given, the following relationship between the voltages described in Equations (2) and (3),

$${V}_{206 a} - {V}_{206 b} = {R}_{L} \times I \qquad ( 4 )$$

the x-y coordinates (u, v) of the location of the applied strain can be determined by:

$$u = k \times X \qquad ( 5 )$$

$$v = \frac{{R}_{Res i d u a l} \times S}{ρ} \qquad ( 6 )$$

where ρ and S are the resistivity and cross section of the segmented conducting tracks 204, respectively.

To localize additional applied strains, other electrode-grounding combinations may be involved. When an additional strain of a same intensity is applied at a second location with coordinates (u′, v′) (e.g., second location 210 in FIG. 2) between electrode 206a and electrode 206b, corresponding voltages can be expressed as:

$${V}_{206 a} = [ {R}_{f o a m} + {R}_{r e s i d u a l - 1} ] \times I \qquad ( 7 )$$

$${V}_{206 b} = [ {R}_{206 b} ‖ ( {R}_{f o a m} + {R}_{r e s i d u a l - 2} ) ] \times I \qquad ( 8 )$$

where R_{206b} is the equivalent resistance associated with equation (3) and R_{residual-1} and R_{residual-2} are the electrical resistances between the second location and electrode 206a and electrode 206b, respectively, which are correlated as follows:

$${R}_{L} = {R}_{r e s i d u a l - 1} + {R}_{r e s i d u a l - 2} \qquad ( 9 )$$

A location of applied strain can be referred to as a contact point. Grounding electrode 206a can locate a closest contact point to an origin using equation (2). Satisfying equation (4) can imply that the contact point does not lie between two adjacent electrodes, such as electrode 206a and electrode 206b. With such an excitation scheme, grounding each electrode can determine two parallel resistances corresponding to left and right track segments between the grounded electrode and closest contact points to the left and right. Assuming that only one contact point is selected in each L-segment and considering two contact points at a left and right side of the electrode 206b, a right parallel resistance, R_{right}=R_{206b}, can be determined using these following steps:
1. Step 1: R_{residual-2}=R_{L}−R_{residual-1}
2. Step 2: Use equation (8) to determine R_{206b}

The foam resistance, R_{foam}, at the second location (u′, v′) can be determined by different means. For instance, the foam resistance can be determined by simultaneously short-circuiting electrode 206a and electrode 206b and isolating all tracks to the right of electrode 206b as in FIG. 3C. FIG. 3C is a schematic of an equivalent electric circuit 320 for a multilayer sensor system with a current excitation source 110 and two short-circuited electrodes according to certain aspects of the present disclosure. Assuming that R′ₒᵤₜ is very large, an expression for the output voltage Vout for the equivalent electric circuit 320 can be given by:

$${V}_{out} = [ {R}_{f o a m} + ( {R}_{r e s i d u a l - 1} // {R}_{r e s i d u a l - 2} ) ] \times I \qquad ( 10 )$$

In an alternative approach, an electric current can be applied to electrode 206a, an upper layer (e.g., top layer 104 of FIG. 1A or FIG. 1B) of the multilayer sensor can be grounded, and all other electrodes, including electrode 206b, can be unconnected. Such an alternative approach can lead to a voltage at electrode 206a given by:

$${V}_{out} = [ {R}_{f o a m} + {R}_{r e s i d u a l - 1} ] \times I \qquad ( 11 )$$

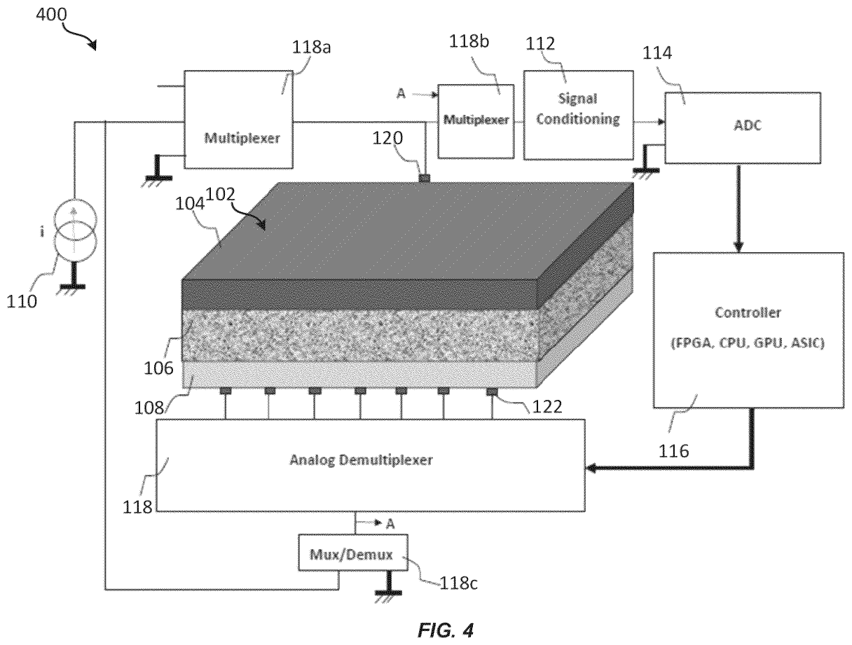

Such an excitation scheme that can involve connecting electrodes to an excitation source or to ground, or leaving electrodes disconnected can involve multiple multiplexers, such as the multiple multiplexers shown in FIG. 4.

FIG. 4 is a schematic of a multilayer sensor system 400 with a current excitation source 110 and multiple multiplexers (e.g., analog demultiplexer 118, multiplexer 118a, multiplexer 118b, and mux/demux 118c) according to certain aspects of the present disclosure. The multilayer sensor system 400 can include a multilayer sensor 102, the current excitation source 110, a signal conditioning unit 112, an analog-to-digital converter (ADC) 114, a controller 116, and an analog demultiplexer 118. The multilayer sensor 102 can include multiple layers, such as a top layer 104, a middle layer 106, and a bottom layer 108. While three layers are shown in the multilayer sensor 102 in FIG. 4, the multilayer sensor 102 can include any number of layers. In some examples, the multilayer sensor 102 can include multiple stacks of multilayers. For example, the multilayer sensor 102 can include any number of stacks of three-layer multilayers. Each stack can include a multilayer with a different number of layers. As an example, the multilayer sensor 102 can include three stacks of two-layer sensors on top of four stacks of three-layer sensors.

A surface of the top layer 104 can include an electrode 120. While a single electrode is shown on the surface of the top layer 104 in FIG. 4, any number of electrodes can be included on the surface of the top layer 104 including zero electrodes. A surface of the bottom layer 108 can include electrodes 122. While seven electrodes are shown on the surface of the bottom layer 108 in FIG. 4, for simplicity only one electrode in labeled in FIG. 4. Any number of electrodes can be included on the surface of the bottom layer 108 including zero electrodes. The electrode 120 and the electrodes 122 can be placed along a boundary of the multilayer sensor 102.

In some examples, the middle layer 106 can be a compressible layer with an electric resistance that can vary with applied strain. For example, the resistance of the middle layer 106 can be very high for zero applied strain and can substantially reduce as a function of the applied strain. The top layer 104 and the bottom layer 108 can include a very high electrically conductive medium, a resistance of which can change only marginally as a function of temperature or strain contacts. The electrically conductive medium can be a highly conductive material. In some examples, the electrically conductive medium of the bottom layer 108 can be an insulating substrate with segmented conductive tracks on a sensor boundary.

The controller 116 can be a FPGA, a CPU, a GPU, or an ASIC. The electrode 120 can be electrically coupled to the top layer 104 and to the current excitation source 110. The electrodes 122 can be electrically coupled to the bottom layer 108 and to the analog demultiplexer 118. In some examples, a single electrode of the electrodes 122 can be connected to ground at any time through the analog demultiplexer 118. The analog demultiplexer 118 can be electrically coupled to the controller 116, which can configure the analog demultiplexer 118.

Additionally, the multilayer sensor system 400 can include additional multiplexers, such as multiplexer 118a, multiplexer 118b, and mux/demux 118c. In FIG. 4, the multilayer sensor system 400 is shown to include three additional multiplexers. In other examples, the multilayer sensor system 400 can include any number of additional multiplexers. The additional multiplexers can enable an excitation scheme for the multilayer sensor system 400. Specifically, the additional multiplexers can enable the multilayer sensor system 400 to select electrodes (such as any of electrodes 122) for either connection to the current excitation source 110, connection to ground, or disconnection. Although the multilayer sensor system includes the current excitation source 110, in other examples, the multilayer sensor system 400 can include a voltage excitation source, such as voltage excitation source 160 from FIG. 1B.

An additional multiplexer, such as multiplexer 118a, can include an unconnected input. The unconnected input can be used to compensate for temperature-induced resistance variations that may occur in the multilayer sensor 102, such as within L-segments, such as L-segments included in segmented conducting tracks 204 shown in FIG. 2. The compensation can be accomplished by isolating an upper conducting layer, such as top layer 104 and connecting the current excitation source 110 (or voltage excitation source) to adjacent electrodes. In a case of a current excitation, a corresponding temperature dependent L-segment resistance can be given by:

$${R}_{L} ( T ) = \frac{{V}_{out}}{I} \qquad ( 12 )$$

To assist in compensating for the temperature dependence, an additional analog demultiplexer similar to the analog demultiplexer 118 can connect a pair of electrodes to the current excitation source 110 or to ground.

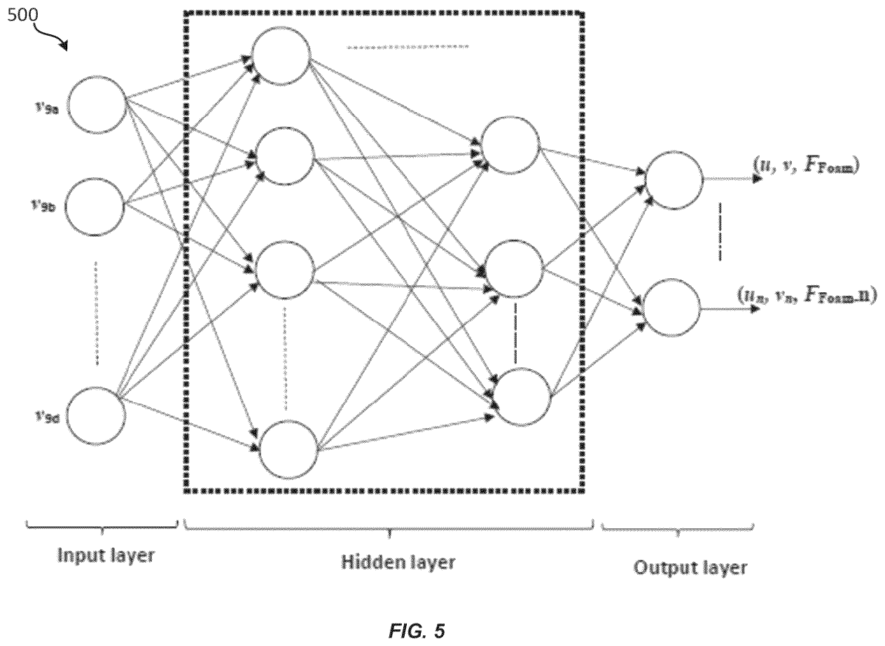

FIG. 5 is a schematic of an ANN 500 for a multilayer sensor system according to certain aspects of the present disclosure. Examples of the multilayer sensor system can include multilayer sensor system 100 from FIG. 1A, multilayer sensor system 150 from FIG. 1B, or multilayer sensor system 400 from FIG. 4. A complexity of the multilayer sensor system can increase with an increase in a number of locations of applied strain within the multilayer sensor system. The ANN 500 can receive a series of voltage values following a separate grounding of each electrode of the multilayer sensor system. The series of voltage values can correspond to an input layer of the ANN 500. The input layer can be followed by hidden and output layers of the ANN 500. The ANN 500 can provide as outputs coordinates (from (u, v) to (uₙ, vₙ)) for n possible locations of applied strain.

FIG. 5 shows a multilayer perception (MLP) neural network architecture. Other algorithms can be considered. Examples of other algorithms can include a machine-learning model, a perceptron neural network, a hidden Markov model neural network (HMM), a convolution neural network or any other neural network that receives input voltage data and generates outputs as illustrated in FIG. 5. Alternatively, the other algorithms can include a non-neural network algorithm that uses equations (1) to (12).

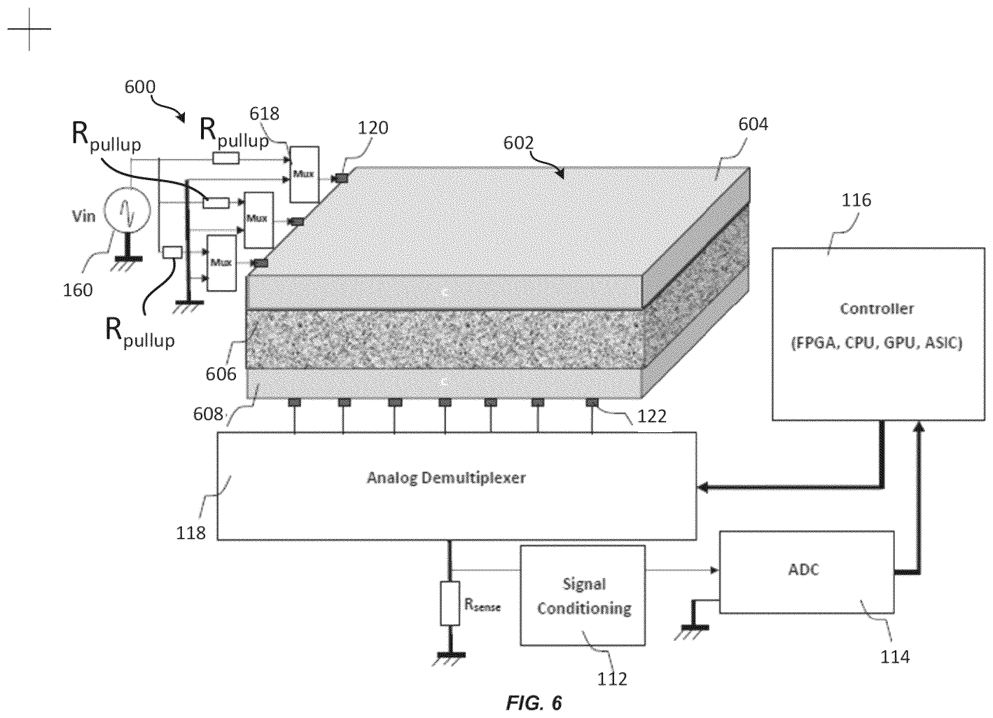

FIG. 6 is a schematic of a multilayer sensor system 600 with a voltage excitation source 160 configured to determine multiple locations of applied stress according to certain aspects of the present disclosure. The multilayer sensor system 600 can include a multilayer sensor 602, the voltage excitation source 160, a signal conditioning unit 112, an ADC 114, a controller 116, and an analog demultiplexer 118. The multilayer sensor 602 can include multiple layers, such as a top layer 604, a middle layer 606, and a bottom layer 608. While three layers are shown in the multilayer sensor 602 in FIG. 6, the multilayer sensor 602 can include any number of layers. In some examples, the multilayer sensor 602 can include multiple stacks of multilayers. For example, the multilayer sensor 602 can include any number of stacks of three-layer multilayers. Each stack can include a multilayer with a different number of layers. As an example, the multilayer sensor 602 can include three stacks of two-layer sensors on top of four stacks of three-layer sensors.

A surface of the top layer 604 can include multiple electrodes 120. While three electrodes are shown on the surface of the top layer 604 in FIG. 6, any number of electrodes can be included on the surface of the top layer 604 including zero electrodes. For simplicity only one electrode of the electrodes 120 is labeled in FIG. 6. A surface of the bottom layer 608 can include electrodes 122. While seven electrodes are shown on the surface of the bottom layer 608 in FIG. 6, any number of electrodes can be included on the surface of the bottom layer 108 including zero electrodes. For simplicity, only one electrode of the electrodes 122 is labeled in FIG. 6. The electrodes 120 and the electrodes 122 can be placed along a boundary of the multilayer sensor 102.

In some examples, the middle layer 606 can be a compressible layer with an electric resistance that can vary with applied strain. For example, the resistance of the middle layer 606 can be very high for zero applied strain and can substantially reduce as a function of the applied strain. The top layer 604 and the bottom layer 608 can include a very high electrically conductive medium, a resistance of which can change only marginally as a function of temperature or strain contacts. The electrically conductive medium can be a highly conductive material. In some examples, the electrically conductive medium of the bottom layer 608 and the top layer 604 can be an insulating substrate with segmented conductive tracks (e.g., segmented conductive tracks 204 of FIG. 2) on a sensor boundary. In order to determine multiple locations of applied stress, the bottom layer 608 can include non-intersecting conductive tracks (e.g., parallel tracks) and the top layer 604 can include another set of non-intersecting conductive tracks. A first direction of the non-intersecting conductive tracks of the top layer 604 can be different than a second direction associated with the non-intersecting conductive tracks of the bottom layer 608 to create a matrix array where an intersection between the conducting tracks of the top layer 604 and the conducting tracks of the bottom layer 608 can represent a number of strain contact points. The first direction and the second direction can be offset by an offset angle. The offset angle can take on any value between 0° and 90°.

The controller 116 can be a FPGA, a CPU, a GPU, or an ASIC. The electrodes 120 can be electrically coupled to the top layer 604 and to the voltage excitation source 160. The electrodes 122 can be electrically coupled to the bottom layer 608 and to the analog demultiplexer 118. In some examples, a single electrode of the electrodes 122 can be connected to ground at any time through the analog multiplexer 168. The analog multiplexer 168 can be electrically coupled to the controller 116, which can configure the analog demultiplexer 118. Depending on characteristics of the ADC 114, multiple designs of a signal conditioning circuit can be considered. For instance, the signal conditioning circuit can include a voltage inverter followed by a 75-ohm series resistance to satisfy an impedance matching condition.

Additionally, the multilayer sensor system 600 can include additional multiplexers 618. In FIG. 6, the multilayer sensor system 600 is shown to include three additional multiplexers. For simplicity, only one of the additional multiplexers 618 is labeled. In other examples, the multilayer sensor system 600 can include any number of additional multiplexers. The additional multiplexers 618 can enable an excitation scheme for the multilayer sensor system 600. Specifically, the additional multiplexers 618 can enable the multilayer sensor system 600 to select electrodes (such as any of electrodes 122 or electrodes 120) for either connection to the voltage excitation source 160, connection to ground, or disconnection. The electrodes 120 can be connected to any of the additional multiplexers 618 to be connected either to the voltage excitation source 160, Vᵢₙ, or to ground. Only one single electrode of the electrodes 120 may be grounded in a time-multiplexed manner, while all remaining electrodes of the electrodes 120 can be connected to Vᵢₙ through a pullup resistance, Rₚᵤₗₗᵤₚ. Although the multilayer sensor system 600 includes the voltage excitation source 160, in other examples, the multilayer sensor system 600 can include a current excitation source, such as current excitation source 110 from FIG. 1A.

Similar to multilayer sensor system 400 from FIG. 4, the multilayer sensor system 600 can account for temperature variations. A design of the multilayer sensor system can account for electrical resistance fluctuations in the non-intersecting conductive tracks of the top layer 604 and the bottom layer 608. Additional electrodes can be added to an opposite side of each of the non-intersecting conductive tracks of both the top layer 604 and the bottom layer 608. Accounting for temperature variations can involve applying an electric current to one end of a non-intersecting conducting track and measuring and/or recording a voltage for the non-intersecting conducting track while an electrode on the opposite side of the non-intersecting conducting track is ground.

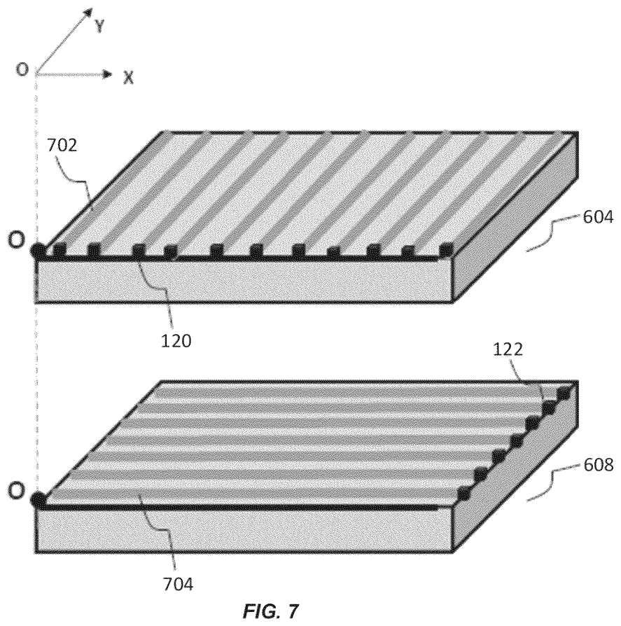

FIG. 7 is a schematic of two layers of a multilayer sensor system according to certain aspects of the present disclosure. The multilayer sensor system can be, for example, multilayer sensor system 600 from FIG. 6. The two layers can include a top layer 604 and a bottom layer 608 of the multilayer sensor system. The top layer 604 can include conducting tracks 702. For simplicity, only one conducting track of the conducting tracks 702 is labeled in FIG. 7. Although 11 conducting tracks are shown on the top layer 604 in FIG. 7, the conducting tracks 702 can include any number of conducting tracks. The top layer 604 can also include electrodes 120. For simplicity, only one electrode of the electrodes 120 is labeled in FIG. 7. The electrodes 120 can be electrically coupled to the conducting tracks 702. Although, a number of electrodes 120 can be equivalent to a number of conducting tracks 702, the top layer 604 can include any number of electrodes 120. The electrodes 120 can be placed along a boundary of the top layer 604.

The bottom layer 608 can include conducting tracks 704. For simplicity, only one conducting track of the conducting tracks 704 is labeled in FIG. 7. Although seven conducting tracks are shown on the bottom layer 608 in FIG. 7, the conducting tracks 704 can include any number of conducting tracks. The bottom layer 608 can also include electrodes 122. For simplicity, only one electrode of the electrodes 122 is labeled in FIG. 7. The electrodes 122 can be electrically coupled to the conducting tracks 704. Although, a number of electrodes 122 can be equivalent to a number of conducting tracks 704, the bottom layer 608 can include any number of electrodes 122. The electrodes 122 can be placed along a boundary of the bottom layer 608.

An orientation of the conducting tracks 702 on the top layer 604 can be different than an orientation of the conducting tracks 704 on the bottom layer 608. The conducting tracks 702 can be offset from the conducting tracks 704 by an offset angle. The offset angle can take on any value between 0° and 90°. In FIG. 7, the conducting tracks 704 are oriented along an x axis perpendicular to the conducting tracks 702, which are oriented along a y axis. An intersection between the conducting tracks 702 of the top layer 604 and the conducting tracks 704 of the bottom layer 608 can represent a number of strain contact points. For example, in FIG. 7, the conducting tracks 702, when overlayed upon the conducting tracks 704, intersect the conducting tracks 704 in 77 locations, representing 77 possible strain contact points.

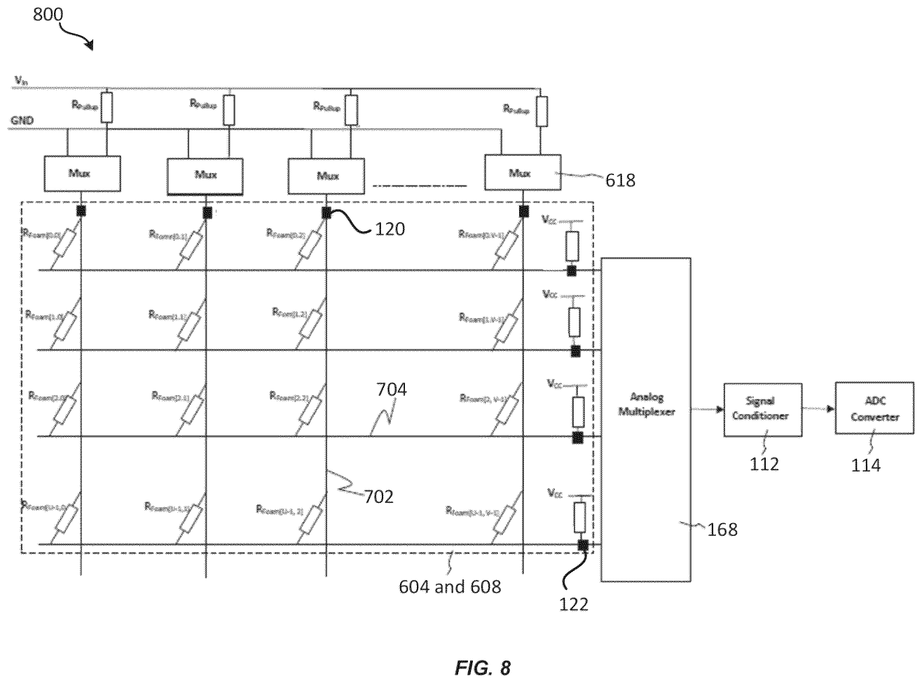

FIG. 8 is a schematic top view of an equivalent circuit 800 of a multilayer sensor system configured to determine multiple locations of applied stress according to certain aspects of the present disclosure. The multilayer sensor system can be equivalent to, for example, multilayer sensor system 600 from FIG. 6. The multilayer sensor system can include a voltage excitation source or a current excitation source, an analog multiplexer 168, a signal conditioning unit 112, an ADC 114, additional multiplexers 618, and a multilayer sensor. The multilayer sensor system can also include multiple pullup resistors with resistances, Rₚᵤₗₗᵤₚ. For simplicity, only one of the additional multiplexers 618 is labeled. The multilayer sensor can include several layers including a top layer 604 and a bottom layer 608. The multilayer sensor can also include a middle layer. The middle layer can be a compressible layer, an electric resistance of which can be very high for zero applied strain and can substantially reduce as a function of the applied strain. The middle layer can include a strain-compressible material, such as foam. A resistance of the middle layer can be referred to as R_{foam}, which can be stress dependent and thus, location dependent.

The top layer 604 can include conducting tracks 702. For simplicity, only one conducting track of the conducting tracks 702 is labeled in FIG. 8. Although four conducting tracks are shown on the top layer 604 in FIG. 8, the conducting tracks 702 can include any number of conducting tracks. The top layer 604 can also include electrodes 120. For simplicity, only one electrode of the electrodes 120 is labeled in FIG. 8. The electrodes 120 can be electrically coupled to the conducting tracks 702. Although, a number of electrodes 120 can be equivalent to a number of conducting tracks 702, the top layer 604 can include any number of electrodes 120. The number of electrodes 120 can be denoted V. The electrodes 120 can be placed along a boundary of the top layer 604.

The bottom layer 608 can include conducting tracks 704. For simplicity, only one conducting track of the conducting tracks 704 is labeled in FIG. 8. Although four conducting tracks are shown on the bottom layer 608 in FIG. 8, the conducting tracks 704 can include any number of conducting tracks. The bottom layer 608 can also include electrodes 122. For simplicity, only one electrode of the electrodes 122 is labeled in FIG. 8. The electrodes 122 can be electrically coupled to the conducting tracks 704. Although, a number of electrodes 122 can be equivalent to a number of conducting tracks 704, the bottom layer 608 can include any number of electrodes 122. The number of the electrodes 122 can be denoted U. The electrodes 122 can be placed along a boundary of the bottom layer 608.

An orientation of the conducting tracks 702 on the top layer 604 can be different than an orientation of the conducting tracks 704 on the bottom layer 608. The conducting tracks 702 can be offset from the conducting tracks 704 by an offset angle. The offset angle can take on any value between 0° and 90°. In FIG. 8, the conducting tracks 704 are oriented along an x axis perpendicular to the conducting tracks 702, which are oriented along a y axis. An intersection between the conducting tracks 702 of the top layer 604 and the conducting tracks 704 of the bottom layer 608 can represent a number of strain contact points. For example, in FIG. 8, the conducting tracks 702, when overlayed upon the conducting tracks 704, intersect the conducting tracks 704 in 16 locations, representing 16 possible strain contact points. The conducting tracks 702, 704 can form a U×V matrix array of sensor points of contact. In the U×V matrix, the conducting tracks 702 can be referred to as columns of the U×V matrix, and the conducting tracks 704 can be referred to as rows of the U×V matrix.

An algorithm associated with the multilayer sensor system can involve selecting one column j, grounding an electrode (electrode 120ⱼ) that corresponds to the selected column, and feeding all other electrodes to Vᵢₙ. Whether a strain is applied at a contact point along a column different than column j or not, an output corresponding to row i can yield zero volts unless a corresponding foam resistance R_{foam}[i, j] is zero, corresponding to a full contact at location [i,j]. Such an excitation design can also detect a strain intensity at location [i,j] if Rₚᵤₗₗᵤₚ»R_{foam}[i,j]. The algorithm steps can be repeated for each column in the U×V matrix. The multiple pullup resistors in the multilayer sensor system can help avoid a short circuit that may occur when simultaneous applied strain contacts occur along both selected and unselected columns. The analog multiplexer 168 may connect outputs of each row to the ADC 114 for further processing.

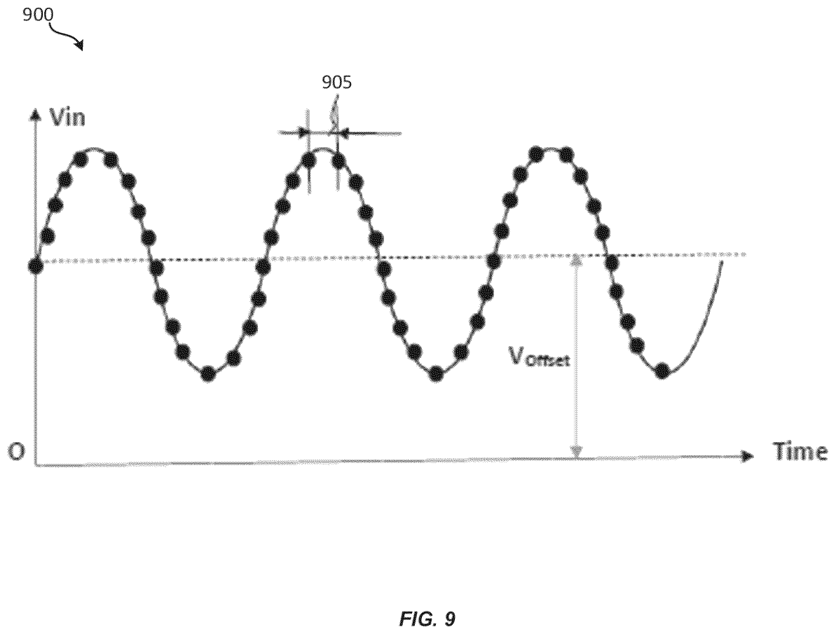

FIG. 9 is a graph 900 of excitation voltage Vᵢₙ as a function of time for a multilayer sensor system according to certain aspects of the present disclosure. The excitation voltage can have a sinusoidal time dependence with an offset voltage V_{offset} from zero. The excitation voltage can be applied periodically along a sinusoidal alternating current (AC) overlay with a time period 905 between excitation voltage applications. The time period 905 can be referred to as a sampling period. A switching process for multiplexers of the multilayer sensor system can occur several times during a single cycle with time period 905, which can lead to a high speed data acquisition throughput. An AC voltage signal, such as the excitation voltage Vᵢₙ shown in FIG. 9, can avoid direct current (DC) interference noises and can be compatible with ADC integrated circuits (ICs), which can include high pass filtering.

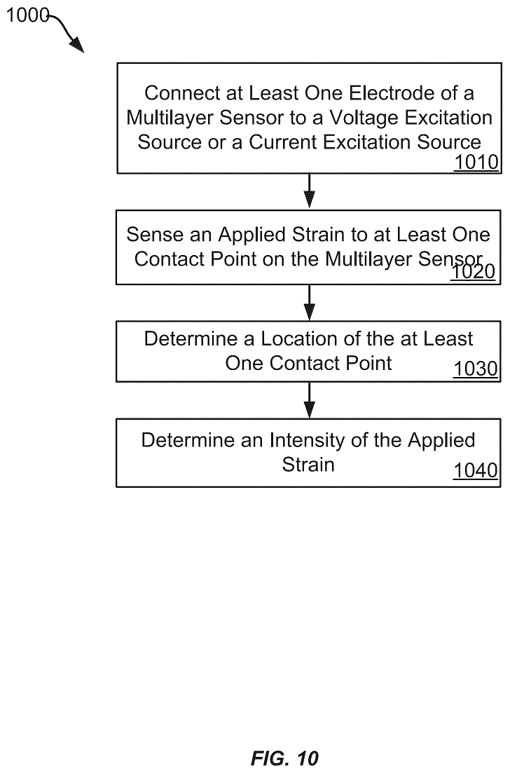

FIG. 10 is a flow chart of a process 1000 for determining locations and intensities of applied strains on a multilayer sensor system according to certain aspects of the present disclosure. Examples of the multilayer sensor system can include multilayer sensor system 100 from FIG. 1A, multilayer sensor system 150 from FIG. 1B, multilayer sensor system 400 from FIG. 4, or multilayer sensor system 600 from FIG. 6. Operations of processes may be performed by software, firmware, hardware, or a combination thereof. Other examples can involve more operations, fewer operations, different operations, or a different order of operations than shown in FIG. 10. The operations of the process 1000 can begin at block 1010.

At block 1010, the process 1000 involves connecting at least one electrode of a multilayer sensor to a voltage excitation source or a current excitation source. Examples of the at least one electrode can include any of electrodes 120, electrodes 122, or electrodes 206a-e from any of FIGS. 1-9 above. Examples of the voltage excitation source can include voltage excitation source 160 shown in FIG. 1B, FIG. 3A, or FIG. 6. Examples of the current excitation source can include current excitation source 110 shown in FIG. 1A, FIG. 3B, FIG. 3C, or FIG. 4. In some examples, a multiplexer can select the at least one electrode and cause an electrical connection between the at least one selected electrode and the voltage excitation source or the current excitation source.

The multilayer can include several layers, such as three layers. The several layers can include a top layer, a middle layer, and a bottom layer. In some examples, the top layer and the bottom layer can be electrically conductive layers and the middle layer can include a strain-compressible material having an electrical resistance that decreases with an increase of applied strain. Since applied strain can vary by location on the multilayer sensor, the electrical resistance of the middle layer can vary by position and, in some examples, can help determine locations of contact points for applied strain. The electrically conductive layers can include electrodes on boundaries of the layers.

In some examples, either one or both of the top layer and bottom layer can include segmented conducting tracks on an insulating substrate. The segmented conducting tracks can be attached to the insulating substrate using an adhesion technique, such as gluing or sewing. The segmented conducting tracks can feature a zigzag shape of continuous L-shaped patterns of that covers an entire length of the top layer or bottom layer. In some examples, when both the top layer and bottom layer include segmented conducting tracks, the segmented conducting tracks can form parallel lines on each of the layers. An orientation of the parallel lines on the top layer can be different than an orientation of the parallel lines on the bottom layer. For example, the top layer parallel lines can be perpendicular to the bottom layer parallel lines.

At block 1020, the process 1000 involves sensing a strain applied to at least one contact point on the multilayer sensor. The at least one contact point can be a location on a surface of any of the layers of the multilayer sensor. For example, the at least one contact point can be a location on a segmented conducting track on a surface of an electrically conductive layer of the multilayer sensor. In some examples, sensing the strain can involve sensing multiple strains applied at different locations on the multilayer sensor. The multiple strains can be sensed simultaneously. Sensing a strain can include sensing a strain intensity associated with the strain.

At block 1030, the process 1000 involves determining a location of the at least one contact point. Determining the location can involve measuring data indicating electrical property measurements associated with the multilayer sensor. Measuring electrical properties can involve applying an excitation signal (e.g., excitation voltage or excitation current) to electrodes on the multilayer sensor and measuring an electrical response to the excitation signal. The electrical response can involve a voltage, current, or electrical resistance output. The electrodes can be electrodes on a same layer or different layers. In some examples, the electrodes can be adjacent electrodes on the same layer. The electrical resistance can be associated with a layer of the multilayer sensor, a segmented conducting track of a layer, or a portion of the segmented conducting track. The location of the at least one contact point can be determined based at least in part on the electrical response. In some examples, locations of multiple contact points of applied strains can be determined with the multilayer sensor. In some examples, an algorithm can be used to determine the location of the at least one contact point.

At block 1040, the process 1000 involves determining an intensity of the applied strain. Determining the intensity can involve measuring data indicating electrical property measurements associated with the multilayer sensor. Measuring electrical properties can involve applying an excitation signal (e.g., excitation voltage or excitation current) to electrodes on the multilayer sensor and measuring an electrical response to the excitation signal. The electrical response can involve a voltage, current, or electrical resistance output. The electrodes can be electrodes on a same layer or different layers. In some examples, the electrodes can be adjacent electrodes on the same layer. The electrical resistance can be associated with a layer of the multilayer sensor, a segmented conducting track of a layer, or a portion of the segmented conducting track. The intensity of the applied strain can be determined based at least in part on the electrical response. In some examples, intensities of multiple applied strains can be determined with the multilayer sensor. In some examples, an algorithm can be used to determine the intensities of the applied strain.

In some examples, the multilayer sensor system can be a component of a monitoring operation. For example, the multilayer sensor system can be included in wearable devices. The wearable devices can provide real-time data regarding health of a patient wearing the wearable devices. A controller of the multilayer sensor system can compare determined applied strain intensities to threshold intensity values. If a determined intensity exceeds a threshold intensity value, a monitoring response can be initiated. The monitoring response can be, for example, sending a notification, modifying an aspect of the monitoring operation, outputting the intensity value to monitoring hub, etc. In some examples, the threshold intensity values can depend on a contact point location.

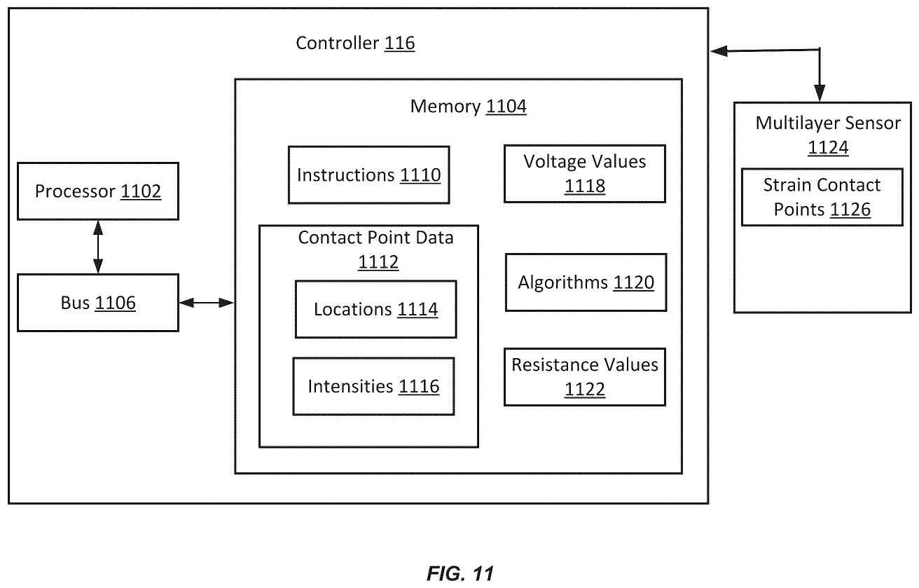

FIG. 11 is a block diagram of a controller 116 for a multilayer sensor system according to certain aspects of the present disclosure. Examples of the multilayer sensor system can include multilayer sensor system 100 from FIG. 1A, multilayer sensor system 150 from FIG. 1B, multilayer sensor system 400 from FIG. 4, or multilayer sensor system 600 from FIG. 6. As shown, the controller 116 includes a processor 1102 communicatively coupled to memory 1104. The processor 1102 can include one processing device or multiple processing devices. Non-limiting examples of the processor 1102 include a Field-Programmable Gate Array (FPGA), an application specific integrated circuit (ASIC), a microprocessor, or any combination of these. The processor 1102 can execute instructions 1110 stored in the memory 1104 to perform operations, such as the operations of process 1000 from FIG. 10. In some examples, the instructions 1110 can include processor-specific instructions generated by a compiler or an interpreter from code written in any suitable computer-programming language, such as C, C++, C #, Python, or Java.

The memory 1104 can include one memory device or multiple memory devices. The memory 1104 can be non-volatile and may include any type of memory device that retains stored information when powered off. Non-limiting examples of the memory 1104 include electrically erasable and programmable read-only memory (EEPROM), flash memory, or any other type of non-volatile memory. At least some of the memory 1104 can include a non-transitory computer-readable medium from which the processor 1102 can read instructions 1110. The non-transitory computer-readable medium can include electronic, optical, magnetic, or other storage devices capable of providing the processor 1102 with the instructions 1110 or other program code. Non-limiting examples of the non-transitory computer-readable medium include magnetic disk(s), memory chip(s), RAM, an ASIC, or any other medium from which a computer processor can read instructions 1110.

The memory 1104 can further include algorithms 1120, voltage values 1118, resistance values 1122, and contact point data 1112. The contact point data 1112 can include data associated with strain contact points 1126 of the multilayer sensor 1124 including locations 1114 and intensities 1116. Examples of the algorithms 1120 can include ANNs, perceptron neural networks, HMM neural networks, convolution neural networks, or any other neural networks or non-neural network algorithms that can receive input voltage data and generate outputs. The controller 116 can receive the voltage values 1118 and resistance values 1122 from the multilayer sensor system. For example, the voltage values 1118 can be associated with electrodes of the multilayer sensor system and the resistance values 1122 can be associated with layers, portions of layers, or components of layers of a multilayer sensor in the multilayer sensor system. The controller 116 can use the voltage values 1118 and/or the resistance values 1122 to determine the locations 1114 and/or intensities 1116 of the strain contact points 1126. In some examples, the controller 116 can use at least one of the algorithms 1120 to determine the locations 1114 and/or intensities 1116.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A strain mapping sensor comprising:
a set of electrodes; and
at least three layers each formed by a rigid material, a flexible material, or a stretchable material, the at least three layers comprising:
a first electrically conductive layer configured to be connected to a voltage or current source;
a second electrically conductive layer; and
a third layer positioned between the first electrically conductive layer and the second electrically conductive layer,
wherein:
the second electrically conductive layer has a first surface and a second surface opposite the first surface,
the third layer is positioned such that the first surface is toward the third layer, and
at least one electrode of the set of electrodes is positioned on the second surface and electrically coupled with the second electrically conductive layer.

2. The strain mapping sensor of claim 1, wherein the third layer comprises a strain-compressible material having an electrical resistance that decreases with an increase of applied strain.

3. The strain mapping sensor of claim 2, wherein the first electrically conductive layer has a third surface and a fourth surface opposite the first surface, wherein the third layer is positioned such that the fourth surface is toward the first electrically conductive layer, and further comprising:
at least another electrode of the set of electrodes is positioned on the third surface and electrically coupled with the first electrically conductive layer.

4. The strain mapping sensor of claim 3, wherein the at least another electrode is further electrically coupled with the voltage or current source.

5. The strain mapping sensor of claim 3, wherein the second electrically conductive layer comprises electrically conductive tracks and an electrically isolated substrate, wherein the electrically conductive tracks are attached to the electrically isolated substrate according to a pattern that allows detection of both location and an intensity of strain applied to the third layer.

6. The strain mapping sensor of claim 5, wherein the electrically conductive tracks are glued or sewn onto the electrically isolated substrate.

7. The strain mapping sensor of claim 5, wherein the electrically conductive tracks comprise uniform conductive tracks attached to the electrically isolated substrate according to the pattern such that an electrical conductivity remains uniform when the strain is applied.

8. The strain mapping sensor of claim 1, further comprising:
an analog-to-digital converter (ADC) electrically coupled with the set of electrodes and configured to output, to a digital circuit, data indicating electrical property measurements.

9. The strain mapping sensor of claim 1, further comprising:
the voltage or current source, wherein the voltage or current source includes at least one of: an alternating current (AC) current source, a direct current (DC) current source, an AC voltage source, or a DC voltage source; and
at least one analog multiplexer configured to select at least one electrode from the set of electrodes such that an electrical property measurement associated with the at least one electrode corresponds to a measurement channel.

10. The strain mapping sensor of claim 9, wherein the third layer is thermally isolated from at least the second electrically conductive layer, and wherein the electrical property measurement comprises an electrical resistance measurement between adjacent electrodes.

11. The strain mapping sensor of claim 9, further comprising:
a controller configured to control the voltage or current source and a sequence of selecting one or more measurement channels from among a plurality of measurement channels.

12. The strain mapping sensor of claim 11, wherein the controller comprises a field programmable gate array (FPGA), a central processing unit (CPU), a graphics processing unit (GPU), or an application-specific integrated circuit (ASIC).

13. The strain mapping sensor of claim 11, wherein the controller is further configured to:
receive electrical property measurements across the plurality of measurement channels; and
input the electrical property measurements to a machine-learning model trained to output at least one of a location or a compression resistance associated with an applied strain.

14. The strain mapping sensor of claim 1, wherein the third layer comprises a strain-compressible material having an electrical property that varies based on strain applied to the third layer.

15. The strain mapping sensor of claim 1, wherein the second electrically conductive layer comprises segmented electrically conductive tracks arranged in a pattern.

16. The strain mapping sensor of claim 15, wherein the pattern enables detection of at least one of a location or a strain intensity at a point where strain is applied to the third layer.

17. The strain mapping sensor of claim 1, wherein the first electrically conductive layer comprises additional segmented electrically conductive tracks.

18. The strain mapping sensor of claim 1, further comprising:
an analog-to-digital converter (ADC) having an input that is electrically coupled with one or more electrodes positioned on the first electrically conductive layer;
a controller electrically coupled with an output of the ADC; and
an analog multiplexer electrically coupled with an output of the controller and one or more electrodes positioned on the second electrically conductive layer.

19. The strain mapping sensor of claim 1, further comprising:
an analog-to-digital converter (ADC);
a controller electrically coupled with an output of the ADC; and
an analog multiplexer electrically coupled with an output of the controller and one or more electrodes positioned on the second electrically conductive layer.

20. The strain mapping sensor of claim 1, further comprising:
a multiplexer electrically coupled with one or more electrodes positioned on the first electrically conductive layer; and
an analog multiplexer electrically coupled with one or more electrodes positioned on the second electrically conductive layer.
